(19) United States
(12) Patent Application Publication
(10) Pub. No.: US 2010/0150625 A1
(43) Pub. Date: Jun. 17, 2010

(54) IMAGE FORMING APPARATUS AND FIXING APPARATUS

(75) Inventors: Toshihiro SONE, Kanagawa (JP); Kazuhiko KIKUCHI, Kanagawa (JP); Satoshi KINOUCHI, Tokyo (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/637,462

(22) Filed: Dec. 14, 2009

Related U.S. Application Data
(60) Provisional application No. 61/138,084, filed on Dec. 16, 2008.

(51) Int. Cl. G03G 15/20

(52) U.S. Cl. 399/329

(57) ABSTRACT

According to an embodiment of the invention, a fixing apparatus includes, a first endless body configured to be heated by a heating mechanism and maintain temperature reached by the heating, a second endless body configured to fix a visualizing agent supported by a sheet medium on the sheet medium in cooperation with the first endless body, a heat equalizing member configured to be located in a predetermined position on an inner side of the first endless body and apply, to the first endless body, tension for supplying heat, and a heat accumulating member configured to have a large heat capacity compared with a heat capacity of the heat equalizing member and to be located in a predetermined position on the inner side of the first endless body and apply, to the first endless body, tension for supplying heat.

### CROSS-REFERENCE TO RELATED APPLICATION

This application is based upon and claims the benefit of priority from: U.S. Provisional Application No. 61/138,084 filed on Dec. 16, 2008, the entire contents of which are incorporated herein by reference.

### TECHNICAL FIELD

The present invention relates to a fuser apparatus of an image forming apparatus and a fixing member.

### BACKGROUND

In an MFP (Multi-Functional Peripheral) as an image forming apparatus, a system for using a thermofusible toner as a visualizing material for visualizing an image is well-known as an electrophotographic system.

The MFP of the electrophotographic system visualizes a latent image with a visualizing material called toner. In the electrophotographic system, the toner is moved onto a recording medium by transfer.

A part of the toner transferred on the recording medium is integrated with and fixed on the recording medium by pressure and heat provided by a fixing apparatus.

The fixing apparatus generally adopts a structure in which rollers are arranged to set rotation axes thereof parallel to each other, predetermined pressure is applied between the rollers, and predetermined heat is provided from at least one roller. One or both of the rollers may be replaced with an endless belt.

When the recording medium moves in a fixing area between the rollers (an area where the rollers are in contact with each other in a direction orthogonal to the rotation axes), the toner remaining on the recording medium is fused by heat and a part of the toner is integrated with an output medium.

The fixing apparatus cannot show sufficient fixing ability in a fixed period until the fixing apparatus obtains heat enough for fusing the toner.

When heat stored by the fixing apparatus, i.e., a heat capacity is increased, time until the fixing apparatus obtains the heat enough for fusing the toner increases. On the other hand, the fixing apparatus can supply the heat to a large number of recording media that should be integrated with the toner (a temperature fall is small).

When the heat stored by the fixing apparatus, i.e., the heat capacity is minimized, the time until the fixing apparatus obtains the heat enough for fusing the toner may be short. However, when there are a large number of recording media that should be integrated with the toner or recording media are thick, in some case, heat supply ability is insufficient (fixing is stopped because of a factor due to the recording media). Under conditions in which the number of colors and layer thickness of toners for obtaining a photograph image are large, special elements such as difficulty in obtaining a gloss are included.

For example, JP-A-2007-241320 (Document 1) discloses that, in a fixing apparatus configured to fix an image using belts, glossiness, which means a reflected light amount with respect to incident light concerning a photograph image quality, is varied and switching of temperature, linear velocity, and pressure are made unnecessary to obtain desired glossiness.

U.S. Pat. No. 7,043,185B2 (Document 2) discloses that, a fixing belt is laid over a heating roller and a supporting roller, the fixing belt is located between the supporting roller and a counter roller, and a recording medium is caused to pass through a nip of the counter roller and the fixing belt to fix a toner on the recording medium.

However, with Document 1 and Document 2, it is still difficult to solve the temporal factor requested for the heat capacity (temperature rise) and the insufficiency of the heat supply ability.

### SUMMARY

An object of the invention is to eliminate temperature unevenness in a fixed image area while reducing warming-up time.

Another object of the invention is to accurately perform heat-up to fixing temperature corresponding to an image.

According to an aspect of the present invention, there is provided a fixing apparatus comprising: a first endless body which is heated by a heating mechanism and maintain temperature reached by the heating; a second endless body which a visualizing agent supported by a sheet medium on the sheet medium in cooperation with the first endless body; a heat equalizing member located in a predetermined position on an inner side of the first endless body and apply, to the first endless body, tension for supplying heat; and a support member which has a large heat capacity compared with a heat capacity of the heat equalizing member and to be located in a predetermined position on the inner side of the first endless body and apply, to the first endless body, tension for supplying heat.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows a diagram of an example of an image forming apparatus (Multi-Functional Peripheral (MFP)) according to an embodiment of the present invention;

FIG. 2 shows a sectional view of a fixing apparatus included in the image forming apparatus shown in FIG. 1 taken along a plane orthogonal to rotation axes;

FIG. 3 is a graph of a change in fixing temperature that occurs when a first tension providing mechanism and a second tension providing mechanism included in the fixing apparatus shown in FIG. 2 are used independently from each other;

FIG. 4 is a flowchart for explaining an example of a procedure for switching the first tension providing mechanism and the second tension providing mechanism included in the fixing apparatus shown in FIG. 2;

FIGS. 5A and 5B show are diagrams of an example of another configuration of the fixing apparatus shown in FIG. 2; and

FIG. 6 shows a diagram of an example of the configuration of a heat equalizing mechanism included in the first tension providing mechanism in the fixing apparatus shown in FIG. 2.

### DETAILED DESCRIPTION

Hereinafter, an embodiment of the present invention is explained in detail below with reference to the accompanying drawings.

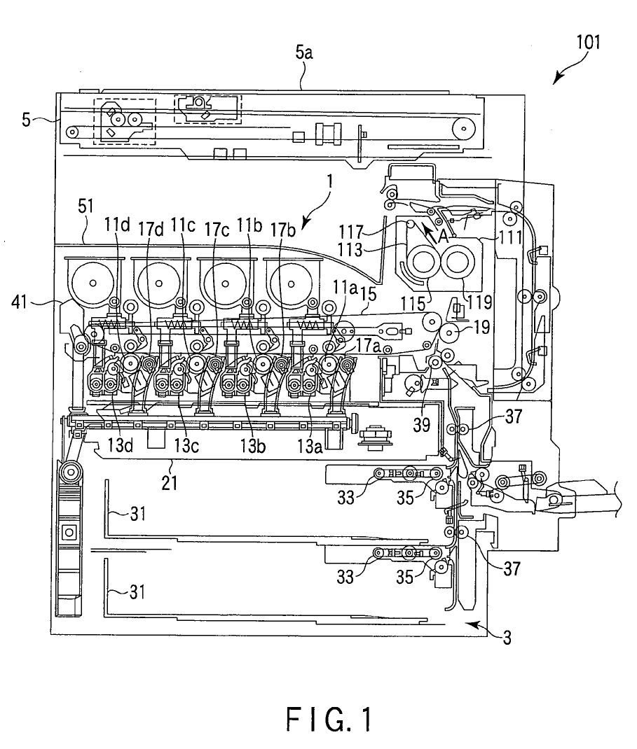

FIG. 1 is a schematic diagram of an image forming apparatus (Multi-Functional Peripheral (MFP)) to which the present invention is applicable.

An image forming apparatus 101 shown in FIG. 1 includes an image forming unit main body 1 configured to output image information as “image output” called, for example, “hard copy” or “print out” with a toner image fixed on a recording medium such as plain paper or a sheet-like medium such as an OHP sheet as a transparent resin sheet (the plain paper representing these media is hereinafter simply referred to as paper), a sheet feeding unit 3 configured to be capable of feeding paper of an arbitrary size used for the image output to the image forming unit main body 1, and an image reading unit 5 configured to capture, as image data, image information, which is formed as an image in the image forming unit main body 1, from a reading object having the image information stored therein (hereinafter referred to as original document).

Although not explained in detail herein, the image reading unit 5 includes a document table (a document glass) 5a configured to support the original document and an image sensor such as a CCD sensor configured to convert the image information into image data. The image reading unit 5 converts, with the CCD sensor, reflected light obtained by irradiating illumination light from an illumination device, which is not explained herein, on the original document set on the document table 5a into an image signal.

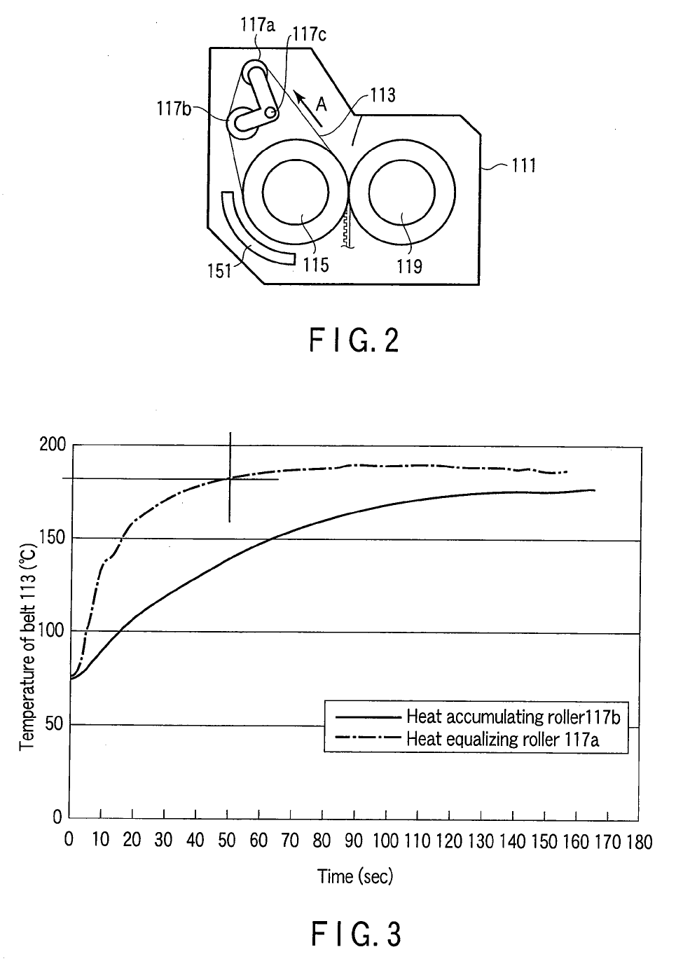

The image forming unit main body 1 includes first to fourth photoconductive drums 11a to 11d configured to hold latent images, developing devices 13a to 13d configured to supply developers, i.e., toners to the latent image held by the photoconductive drums 11a to 11d and develop the latent images; a transfer belt 15 configured to hold, in order, images of the toners held by the photoconductive drums 11a to 11d, first to fourth cleaners 17a to 17d configured to remove the toners remaining on the photoconductive drums 11a to 11d from the respective photoconductive drums 11a to 11d, a moving device 19 configured to move the toner images held by the transfer belt 15 onto the paper, a fuser unit 111 configured to fix the toner images on the paper onto which the toner images are moved, and an exposing device 21 configured to form latent images on the photoconductive drums 11a to 11d. As explained later with reference to FIG. 2, the fuser unit 111 includes an endless belt 113, a first roller 115 configured to rotate to be capable of moving the surface of the endless belt 113 in an arrow A direction, a second roller unit 117 (including a heat equalizing roller 117a, a heat accumulating roller 117b, and a tension lever 117c) configured to apply predetermined tension to the endless belt 113 in cooperation with the first roller 115, and a third roller 119 configured to apply predetermined pressure to the first roller 115 in a position where the endless belt 113 is interposed between the third roller 119 and the first roller 115.

The first to fourth developing devices 13a to 13d store toners of arbitrary colors of Y (yellow), M (magenta), C (cyan), and Bk (black) used for obtaining a color image according to a subtractive process. The first to fourth developing devices 13a to 13d visualize, with any colors of Y, M, C, and Bk, the latent images respectively held by the photoconductive drums 11a to 11d. The colors are arranged in predetermined order determined according to an image forming process and characteristics of the toners.

The transfer belt 15 holds, in order (of formation of the toner images), the toner images of the colors formed by the first to fourth photoconductive drums 11a to 11d and the developing devices 13a to 13d corresponding thereto.

The sheet feeding unit 3 feeds the paper, onto which the toner images are moved, to the moving device 19 at predetermined timing.

Cassettes, which are not explained in detail herein, located in plural cassette slots 31 store the paper of arbitrary sizes. A pickup roller 33 extracts the paper from the cassette corresponding thereto according to image forming operation not explained in detail herein. The sizes of the paper correspond to magnifications requested in image formation and sizes of toner images formed by the image forming unit main body 1.

A separating mechanism 35 prevents two or more pieces of paper from being extracted from the cassette at a time by the pickup roller 33.

Plural conveyance rollers 37 convey one sheet material separated by the separating mechanism 35 to an aligning roller 39.

The aligning rollers 39 send the paper to a transfer position, where the moving device 19 and the transfer belt 15 are set in contact with each other, to be timed to coincide with the transfer of the toner images from the transfer belt 15 by the moving device 19.

The fuser unit 111 fixes the toner images corresponding to the image information on a sheet material and sends, as image output (hard copy or print out), the sheet material to a stock unit 51 located in a space between the image reading unit 5 and the image forming unit main body 1.

The transfer belt 15 holds the toners remaining on the transfer belt 15 (hereinafter referred to as waste toners) and moves the waste toners to a predetermined position according to the movement of a belt surface of the transfer belt 15. A belt cleaner 41 set in contact with the transfer belt 15 in the predetermined position removes the waste toners held by the belt surface of the transfer belt 15 from the transfer belt 15.

FIG. 2 is a sectional view of a fixing apparatus included in the image forming apparatus (MFP) shown in FIG. 1 taken along a plane orthogonal to rotation axes.

In the fuser unit 111, the surface of the endless belt 113 is rotated to be movable in an arrow A direction by the heat equalizing roller 117a or the heat accumulating roller 117b of the second roller unit 117, which is switched as a main roller used when the tension lever 117c applies tension to the endless belt 113, and the first roller 115. In other words, the first roller 115 and the heat equalizing roller 117a or the heat accumulating roller 117b included in the second roller unit 117 apply predetermined tension to the endless belt 113.

An induction coil, which is not explained in detail herein, of an induction heating device 151 as a heating source is located in the outer circumference of the first roller 115. Therefore, while an arbitrary position of the endless belt 113 moves according to the rotation of the first roller 115, the endless belt 113 receives heat generated by the first roller 115 and heat transported by the endless belt 113. It goes without saying that the heat transported by the endless belt 113 is heat transported by the endless belt 113, which receives the heat generated by the first roller 115, to the heat equalizing roller 117a or each of the heat equalizing roller 117a and the heat accumulating roller 117b according to the movement of the belt surface of the endless belt 113.

An induction heating coil (the induction heating device) 151 includes one induction heating coil (one system) and is arranged along the outer circumference of the first roller 115 with the endless belt 113 held between the induction heating coil 151 and the first roller 115. The induction heating coil (the induction heating device) 151 may be arranged in a position on the inner side of the endless belt 113, for example, between the first roller 115 and the second roller unit 117.

For the heating of the first roller 115 by the induction heating device 151, an arbitrary method widely known as IH (Induction Heating) driving such as electric energy control, frequency control, or pulse width control can be used. During warming-up, it is also possible to use full electric power suppliable to the induction heating device 151 at that point.

It goes without saying that a non-contact temperature detecting mechanism 131 detects the temperature of the endless belt 113 near an upstream side of a nip section where the endless belt 113, which receives the heat generated by the first roller 115, is set in contact with the third roller 119. As the non-contact temperature detecting mechanism 131, for example, a thermopile-type (detecting) mechanism is desirably used. However, a contact-type thermistor may also be used.

Further, it goes without saying that the fuser unit 111 includes at least one or all of a cleaning roller configured to remove a toner adhering to the endless belt 113, a toner offset to the third roller 119, or dust or the like, an oil roller configured to improve releasability of the paper (and a toner image integrated with the paper), and the like.

The endless belt 113 includes a sheet (a belt) with fixed releasability and smoothness secured by coating tetrafluoroethylene resin widely known as Teflon (a trademark) on the surface of a resin film having predetermined thickness, which shows heat resistance against temperature up to at least 250° C., or a metal thin film subjected to insulating treatment.

A rotation axis (a rotation center) of the first roller 115 and a rotation axis (a rotation center) of the third roller 119 are located substantially in parallel. The first roller 115 and the third roller 119 receive predetermined pressure from each other between both the rotation axes (rotation centers) (the first roller 115 and the third roller 119 provide the predetermined pressure to the rotation axes (the rotation centers) each other).

The toners remaining on the paper and the paper (on which the toners remain) pass through a fixing area (a nip) where the endless belt 113 and the third roller 119 are set in contact with each other. The toners remaining on the paper move while facing a side opposed to the endless belt 113.

The first roller 115 is obtained by forming, in predetermined thickness, a rubber layer having heat resistance on a shaft of metal and assumes elasticity. The surface of the first roller 115 is improved in releasability and smoothness by a tube including thermoplastic fluorine resin, for example, copolymer (PFA) of perfluoroalkoxyethylene and tetrafluoroethylene. Besides the PFA tube, coating of DLC (Diamond Like Carbon) or the like can also be used.

The third roller 119 is obtained by forming, in predetermined thickness, a rubber layer having heat resistance on a shaft of metal and assumes elasticity. The surface of the third roller 119 is improved in releasability and smoothness by a tube including PFA (thermoplastic fluorine resin). Besides the PEA tube, coating of DLC or the like can also be used.

The heat accumulating roller 117b included in the second roller unit 117 is hollow, i.e., has a shape of a pipe hollow inside and has thickness of, for example, 2 mm. A material of the heat accumulating roller 117b is, for example, iron, stainless steel, or aluminum. The surface of the heat accumulating roller 117b is improved in releasability and smoothness by a tube including PFA (thermoplastic fluorine resin). Besides the PFA tube, coating of DLC or the like can also be used. When stainless steel is used, the PFA tube or the DLC coating can be omitted.

The heat equalizing roller 117a included in the second roller unit 117 is hollow, i.e., has a shape of a pipe hollow inside (a thin metal pipe). A material of the heat equalizing roller 117a is, for example, iron. The heat equalizing roller 117a may be made of stainless steel or Al (aluminum). When the material is iron (or stainless steel), the thickness of the heat equalizing roller 117a is desirably equal to or larger than 0.3 mm.

The heat equalizing roller 117a internally includes a heat equalizing member, i.e., a heat pipe 121.

The heat pipe 121 is made of a material having high thermal conductivity, for example, Al (aluminum) or an alloy containing Al. The materials of the heat pipe 121 and the heat equalizing roller 117a are selected to set the thermal conductivity of the heat pipe 121 higher than the thermal conductivity of the heat equalizing roller 117a. The coefficient of thermal expansion of the heat pipe 121 is set higher than the coefficient of thermal expansion of the heat equalizing roller 117a. The heat equalizing roller 117a has strength for preventing a change from occurring in an outer diameter after the heat pipe 121 expands on the inside (the strength is set according to a combination of physical properties and viscosity, thickness, and the like of a material).

As indicated by an example shown in FIG. 6, both ends of the heat pipe 121 have a conical shape, a spherical shape, or a shape similar to a shape obtained by rotating a parabola, and the heat pipe 121 has a shape of a pipe closed, for example, by welding.

The heat pipe 121 has, for example, an outer diameter of 15.88 mm and thickness of about 0.3 to 0.6 mm. The outer diameter of the heat pipe 121 is smaller by 0.5 to 1 mm in radius compared with the inner diameter of the heat equalizing roller 117a. The outer diameter of the heat pipe 121 is arbitrarily set on the basis of the outer diameter of the heat equalizing roller 117a.

The heat pipe 121 is fixed in a predetermined position on the inner side of the heat equalizing roller 117a by a method of retaining thermal deformation caused by thermal expansion (a method including shrinkage fit or a heating process similar to shrinking fit). For the fixing, bearings (stoppers) 123 having recesses of a conical taper shape or a polygonal shape with the rotation axis (the rotation center) of the heat equalizing roller 117a set as minimum diameter section are located at both the ends of the heat equalizing roller 117a. The outer diameter of the heat pipe 121 pressed against the inner wall of the heat equalizing roller 117a does not return to the original outer diameter because of thermal stress and thermal distortion even when the temperature of the heat pipe 121 returns to the room temperature.

The bearings 123 include decompression holes (center openings) 123a for preventing the bearings 123 from jumping out from the heat equalizing roller 117a.

As a material of the bearings 123, stainless steel is suitable but inexpensive iron can also be used. When iron is used, it is desirable to apply measures against surface slide deterioration such as a reduction in a coefficient of friction or addition of a sliding member (coat of resin that can be used for a slide bearing). Concerning surface protection, special protection is not specified.

In other words, when the heat pipe 121 can uniformly expand in the heat equalizing roller 117a, the heat pipe 121 provides uniform pressure to the inner wall of the heat equalizing roller 117a. Conversely, when the heat pipe 121 expands with a tilt or eccentricity, the heat pipe 121 cannot uniformly provide pressure to the inner wall of the heat equalizing roller 117a. This causes non-uniformity in heat transport properties of the heat pipe 121. When a degree of thermal expansion, i.e., pressure caused on the inside of the heat pipe 121 during heating is high, on condition that the heat pipe 121 does not burst, it can be expected that the heat pipe 121 is uniformly set in contact with the inner wall of the heat equalizing roller 117a and it is recognized that the temperature of the surface of the heat equalizing roller 117a is uniform.

The thermal conductivity of the bearings 123 is lower than the thermal conductivity of the heat equalizing roller 117a. Therefore, the thermal conductivity of the heat pipe 121 is higher than the thermal conductivity of the bearings 123. All of the bearings 123, the heat equalizing roller 117a, and the heat pipe 121 are made of different materials.

The fuser unit 111 shown in FIG. 2 specifies, on the basis of at least one of an amount of the toner remaining on the paper, the thickness of the paper, the number of pieces of the paper requested to be continuously processed, and the like, which of the heat equalizing roller 117a and the heat accumulating roller 117b is preferentially mainly used to apply tension to the endless belt 113.

For example, when the user instructs image formation on thick paper (paper having thickness equal to or larger than fixed thickness), the heat accumulating roller 117b preferentially applies tension to the endless belt 113. Specifically, as indicated by a dotted line in FIG. 2, the heat accumulating roller 117b comes into contact with the endless belt 113 according to CCW (counterclockwise) rotation of the tension lever 117c and predetermined tension is applied to the endless belt 113. When the heat accumulating roller 117b comes into contact with the endless belt 113, the heat equalizing roller 117a also comes into contact with the endless belt 113.

In the method of applying tension to the endless belt 113 preferentially using the heat accumulating roller 117b, tension can also be applied to the endless belt 113 (by the heat accumulating roller 117b) by forming the tension lever 117c, an example of which is shown in FIG. 2, in a linear shape (straight) and turning the supporting section of the heat accumulating roller 117b around the axis of the heat equalizing roller 117a.

Consequently, the endless belt 113 receives the heat stored by the heat accumulating roller 117b. Therefore, in image formation performed by using an arbitrary number of pieces of thick paper, it is possible to prevent fixing properties from being deteriorated because of a fall in temperature of the endless belt 113 and the heat accumulating roller 117b. When requested image output is full color image output, it is possible to improve color development properties. When image output is requested to have glossiness, it is possible to secure a gloss. Time required during warming-up is extended compared with time required when the heat equalizing roller 117a is used.

On the other hand, when there is no particular instruction from the user and during normal warming-up such as during power-on, tension is applied to the endless belt 113 preferentially using the heat equalizing roller 117a. Specifically, as indicated by a solid line in FIG. 2, only the heat equalizing roller 117a comes into contact with the endless belt 113 according to CW (clockwise) rotation (a default position) of the tension lever 117c and predetermined tension is applied to the endless belt 113. Tension with which the endless belt 113 is suspended and stretched by the heat equalizing roller 117a is desirably 8 N/mm on one side, i.e., tension between the heat equalizing roller 117a and the first roller 115 is desirably equal to or smaller than 16 N/mm. When the endless belt 113 is suspended and stretched with tension equal to or larger than 8 N/mm, load is applied to the endless belt 113 (suddenly increases) and the belt is broken or the durable life of the belt is reduced.

In a sleep state in which image forming operation is not performed for fixed time and temperature maintenance during standby of the fuser unit 111 is further suppressed, tension applied to the endless belt 113 by the heat equalizing roller 117a is suppressed to substantially prevent tension from being applied to the endless belt 113 according to CW (clockwise) rotation (a sleep position) exceeding the default position of the tension lever 117c shown in FIG. 2. This makes it possible to further extend the durable life of the endless belt 113.

As explained above, the heat equalizing roller 117a includes the heat pipe 121. Therefor, even when the width (the length along the axial direction of the heat equalizing roller 117a) of the paper output medium is short (the size of the paper is small) compared with the width (effective length) of an effective area of the heat equalizing roller 117a, a temperature difference in the entire length in the longitudinal direction (temperature unevenness in the longitudinal direction) does not substantially occur. The heat equalizing roller 117a integrally includes the heat pipe 121. Therefore, as indicated by actually-measured temperature shown in FIG. 3, if the heat equalizing roller 117a is used, when lower limit temperature requested to fix an image is set to 175° C. and temperature is raised to 180° C. to end warming-up, time necessary until the end of warming-up is about 50 seconds (sec). In other words, warming-up ends in short warming-up time about ¼ to ⅕ as long as warming-up time of warming-up performed by preferentially using the heat accumulating roller 117b.

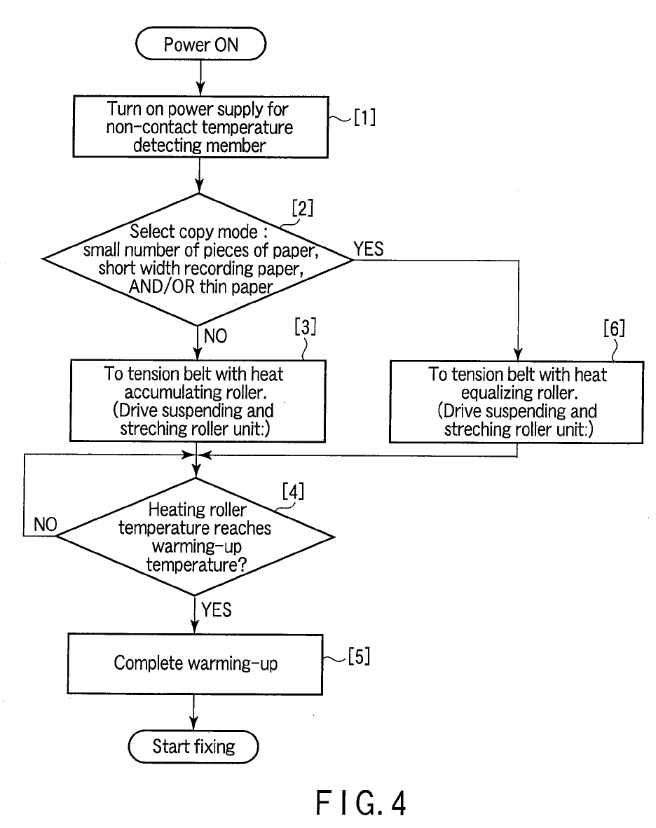

FIG. 4 is a flowchart for more specifically explaining which of the heat equalizing roller 117a and the heat accumulating roller 117b is preferentially used to apply tension to the endless belt 113.

When a power supply for the image forming apparatus 101 is turned on, the non-contact temperature detecting mechanism 131 (see FIG. 2) incorporated in the fuser unit 111 is started and calibration is executed according to reference temperature (Act [1]).

Subsequently, the image forming apparatus 101 specifies a copy mode (a fixing condition concerning the paper and the toner) according to a check result of user input (presence or absence of an instruction from the user) (Act [2]).

If an amount of the toner fixed and remaining on paper, the thickness of paper, the size of paper, the number of pieces of paper requested to be continuously processed, and the like do not respectively meet any of conditions that the number of pieces of paper is small, a size is small (small width), thickness is small (thin paper), and the like (NO in Act 2), the image forming apparatus 101 preferentially uses the heat accumulating roller 117b (applies tension to the endless belt 113 preferentially using the heat accumulating roller 117b) (Act [3]).

The image forming apparatus 101 supplies predetermined power to the induction heating device 151 until the surface temperature of the endless belt 113 downstream in a rotating direction of the first roller 115 detected by the temperature detecting mechanism 131 reaches warming-up end temperature (Act [4]). If the surface temperature reaches the warming-up end temperature, the image forming apparatus 101 completes the warming-up (Act [5]) and starts fixing.

If at least one of the amount of the toner remaining on the paper, the thickness of the paper, the size of the paper, and the number of pieces of the paper requested to be continuously processed and the like, for example, the small size (the small width) can be specified (YES in Act 2), the image forming apparatus 101 applies tension to the endless belt 113 preferentially using the heat equalizing roller 117a (Act [6]).

Thereafter, until the surface temperature of the endless belt 113 downstream in the rotating direction of the first roller 115 detected by the temperature detecting mechanism 131 reaches the warming-up end temperature, the image forming apparatus 101 supplies predetermined power to the induction heating device 151 (Act [4]). If the surface temperature reaches the warming-up end temperature, the image forming apparatus 101 completes the warming-up (Act [5]) and starts fixing.

If the temperature of the first roller 115 does not reach specified temperature within specified time from the start of warming-up, the image forming apparatus 101 determines that abnormality occurs, stops the warming-up, and displays a service call on a display unit (not shown in the figure) or the like of an operation panel.

It goes without saying that, if the target specified temperature (warming-up completion temperature) of the first roller (the heating roller) 115 is different with respect to the size of the paper, the type of the paper, and the thickness of the paper and, for example, the thickness of the paper is large, the target specified temperature is raised to the predetermined temperature.

Concerning a request for high-temperature conditions such as the thick paper, the CHP sheet, and the gloss mode, it is also effective to apply tension to the endless belt 113 with the heat accumulating roller 117b.

In the embodiment, the aluminum material having a small heat capacity and high thermal conductivity is used as the roller for the heat equalizing roller 117a and the roller made of the aluminum material having a heat capacity larger than the heat capacity of the heat equalizing roller 117a is used for the heat accumulating roller 117b. However, the material is not limited to this and it goes without saying the material may be copper, iron, stainless steel, or the like.

It is desirable to prepare a heat pipe structure in at least one roller, for example, the heat equalizing roller 117a.

As explained above, in the normal warming-up, the endless belt (the metal belt) 113 is suspended and stretched by the heat equalizing roller 117a having a small heat capacity. Therefore, the warming-up can be performed in short warming-up time less than one minute. Therefore, it is possible to heat up the endless belt (the metal belt) 113 to the target temperature with small power consumption. It is possible to set conditions for heating the endless belt 113 (elements used for heating) and a heat capacity at any time on the basis of the size and the type of the paper, a request for a gloss, and the like. It is possible to minimize energy loss and waiting time for temperature rise.

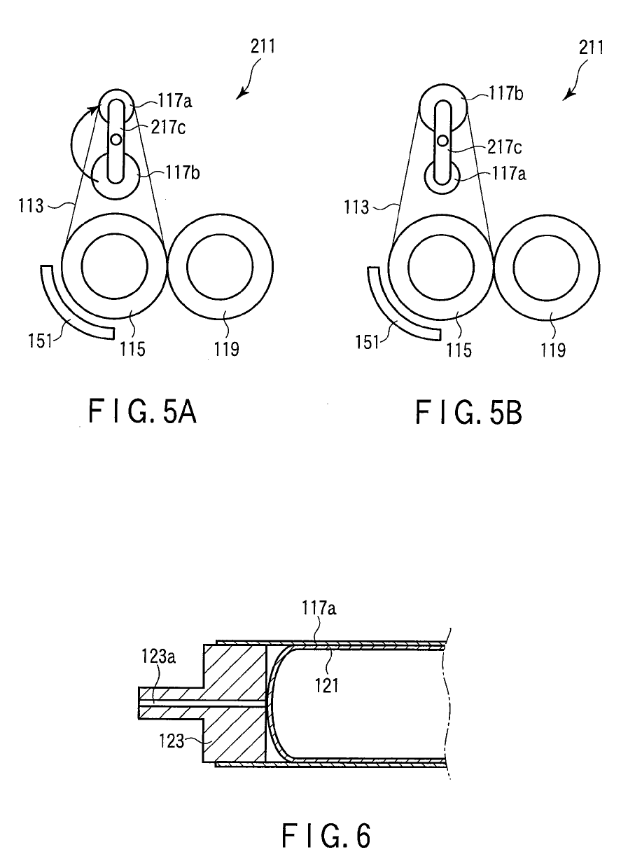

For example, as shown in FIGS. 5A and 5B, it is also possible to easily realize a fuser unit 211 that applies tension to the endless belt 113 from one of the heat equalizing roller 117a and the heat accumulating roller 117b by using a switching lever 217c fixed in the center and rotating the lever 217c with a rotary-type or a reversal-type switching driving source (not shown in the figure).

As explained above, in the fixing apparatus according to the embodiment of the present invention, when the endless belt (the heating mechanism) configured to heat the toner as the visualizing material to a melting point (temperature) is heated up, the heat equalizing roller or the heat accumulating roller is preferentially used on the basis of at least one of the amount of the toner remaining on the paper, the thickness of the paper, the number of pieces of the paper output media requested to be continuously processed, and the like. This makes it possible to prevent fixing properties from being deteriorated in image formation performed by using an arbitrary number of pieces of thick paper. When requested image output is full color image output, it is possible to improve color development properties. When image output is requested to have glossiness, it is possible to secure a gloss. On the other hand, during normal warming-up such as during power-on, it is possible to substantially reduce warming-up time and, concerning a thin medium and a small medium, directly start fixing.

Therefore, an image forming apparatus that can start fixing in a short time while suppressing power consumption is obtained. It is possible to minimize energy loss and waiting time for temperature rise on the basis of the size and the type of the paper output medium, a request for a gloss, and the like.

When fixing temperature is maintained by the heat equalizing roller, it is possible to uniformalize the surface temperature of the roller. When a toner is fixed on paper having small length (width) compared with a length direction (roller width) of the roller, for example, A4-R, A5, or B4 paper, it is possible to prevent the temperature of a section of the roller not set in contact with a transfer medium (an excess section of the roller in the length direction compared to the width of the paper) from undesirably fluctuating.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a first endless body which is heated by a heating mechanism and maintain temperature reached by the heating;
a second endless body which a visualizing agent supported by a sheet medium on the sheet medium in cooperation with the first endless body;
a heat equalizing member located in a predetermined position on an inner side of the first endless body and apply, to the first endless body, tension for supplying heat; and
a support member which has a large heat capacity compared with a heat capacity of the heat equalizing member and to be located in a predetermined position on the inner side of the first endless body and apply, to the first endless body, tension for supplying heat.

2. The apparatus of claim 1, wherein
the heat equalizing member independently applies the tension to the first endless body.

3. The apparatus of claim 1, wherein
the heat accumulating member independently applies the tension to the first endless body.

4. The apparatus of claim 3, wherein
the heat accumulating member applies the tension to the first endless body in cooperation with the heat equalizing member.

5. The apparatus of claim 1, wherein
the heat accumulating member applies the tension to the first endless body in cooperation with the heat equalizing member.

6. The apparatus of claim 1, wherein
the heat equalizing member includes a material having high heat transport ability that closely adheres to an inside thereof because of thermal deformation.

7. The apparatus of claim 6, wherein thermal conductivity of the material having high heat transport ability is higher than thermal conductivity of the heat equalizing member.

8. The apparatus of claim 6, wherein the heat equalizing member independently applies the tension to the first endless body.

9. The apparatus of claim 8, wherein the heat accumulating member applies the tension to the first endless body in cooperation with the heat equalizing member.

10. The apparatus of claim 1, wherein the heat accumulating member and the heat equalizing member are supported by a same pivoting fulcrum and selectively apply the tension to the first endless body.

11. The apparatus of claim 10, wherein the heat accumulating member is pivotably supported with a rotation center of the heat equalizing member as a fulcrum and applies the tension to the first endless body in cooperation with the heat equalizing member.

12. The apparatus of claim 1, wherein the heat accumulating member is pivotably supported with a rotation center of the heat equalizing member as a fulcrum and applies the tension to the first endless body in cooperation with the heat equalizing member.

13. The apparatus of claim 10, wherein the heat equalizing member includes a material having high heat transport ability that closely adheres to an inside thereof because of thermal deformation.

14. The apparatus of claim 13, wherein thermal conductivity of the material having high heat transport ability is higher than thermal conductivity of the heat equalizing member.

15. The apparatus of claim 1, further comprising a third endless body configured to press the first endless body to the second endless body and assist a rise in temperature due to heating of the first endless body.

16. An image forming apparatus comprising:
a visualizing agent providing mechanism configured to supply a visualizing agent to an electrostatically-formed image;
a visualizing agent transferring mechanism configured to transfer the visualizing agent, which is supplied to the image by the visualizing agent providing mechanism, to a sheet medium; and
a fixing apparatus including:
a first endless body which is heated by a heating mechanism and maintain temperature reached by the heating;
a second endless body which a visualizing agent supported by a sheet medium on the sheet medium in cooperation with the first endless body;
a heat equalizing member located in a predetermined position on an inner side of the first endless body and apply, to the first endless body, tension for supplying heat;
a heat accumulating member which has a large heat capacity compared with a heat capacity of the heat equalizing member and to be located in a predetermined position on the inner side of the first endless body and apply, to the first endless body, tension for supplying heat; and
a third endless body which presses the first endless body to the second endless body and assist a rise in temperature due to heating of the first endless body.

17. A toner image fixing method comprising:
applying predetermined tension to an endless body from an inner side thereof with a first member or a second member different from the first member or with both the first and second members;
applying predetermined pressure to the endless body (to which the predetermined tension is applied) from an outer side thereof; and
fixing a visualizing agent supported by a sheet medium to the sheet medium using the endless body.

18. The method of claim 17, wherein
the first member has a first heat capacity and the second member has a second heat capacity larger than the first heat capacity.

19. The method of claim 17, wherein the first member integrally includes a heat transport mechanism having high heat transport speed.

20. The method of claim 19, wherein the first member has a first heat capacity and the second member has a second heat capacity larger than the first heat capacity.
